(19) United States
(12) Patent Application Publication
(10) Pub. No.: US 2026/0039412 A1
(43) Pub. Date: Feb. 5, 2026

(54) ADAPTIVE MODULATION FOR AMBIENT IOT

(71) Applicant: InterDigital Patent Holdings, Inc., Wilmington, DE (US)

(72) Inventors: Erdem Bala, East Meadow, NY (US); Remun Koirala, London (GB); Paul Marinier, Brossard (CA); Moon IL Lee, Melville, NY (US); Ahmed Mostafa, Ottawa (CA); Aata El Hamss, Laval (CA); Martino Freda, Laval (CA); Jongwoo Hong, New York, NY (US); Brian Martin, Farnham (GB)

(73) Assignee: InterDigital Patent Holdings, Inc., Wilmington, DE (US)

(21) Appl. No.: 18/794,657

(22) Filed: Aug. 5, 2024

(51) Int. Cl. H04L 1/00; H04B 17/11; H04L 27/26

(52) U.S. Cl. CPC H04L 1/0003; H04B 17/11; H04L 27/2605

(57) ABSTRACT

A wireless transmit/receive unit (WTRU) may be configured to determine an association between a modulation order and a symbol duration. The WTRU may be configured to transmit a calibration signal. The WTRU may be configured to transmit a broadcast configuration message. The WTRU may be configured to receive a signal with a frequency corresponding to a chip duration. The WTRU may be configured to determine a modulation order of the received signal. The WTRU may be configured to determine data bits of the received signal based on a phase of the received signal over a duration of the symbol duration and the determined modulation order. The modulation order may be a number of phases that a device transmits using a line code or a subcarrier signal. A symbol duration may comprise one or more data bits or chips.

### BACKGROUND

3GPP RAN has started studying ambient Internet of Things (IoT) (AIOT). The devices that are in the scope of the study may have power consumption of about 1 μW to a few hundreds of μW. The devices may transmit using backscattering.

In backscattering, a device reflects a received radio frequency (RF) signal after modulating the signal using a baseband signal. Baseband physical layer processing may use line codes for digital baseband modulation. In a line code, digital bits are encoded into one or a sequence of pulses. For example, bit 1 may be encoded as a pulse with voltage level +A and bit 0 may be encoded as a pulse of voltage level 0. A=1 may be assumed without loss of generality. In another example, bit 1 may be encoded as a pulse with voltage level +A and bit 0 may be encoded as a pulse of voltage level −A. In another example, bit 1 may be encoded as a half-pulse with voltage level 0, or −A, followed by a half-pulse with voltage level A and bit 0 may be encoded as a half-pulse with voltage level +A followed by a half-pulse with voltage level 0, or −A. This last encoding scheme is known as Manchester encoding.

### SUMMARY

A wireless transmit/receive unit (WTRU) may be configured to determine an association between a modulation order and a symbol duration. The WTRU may be configured to transmit a calibration signal. The WTRU may be configured to transmit a broadcast configuration message. The WTRU may be configured to receive a signal with a frequency corresponding to a chip duration. The WTRU may be configured to determine a modulation order of the received signal. The WTRU may be configured to determine data bits of the received signal based on a phase of the received signal over a duration of the symbol duration and the determined modulation order. The modulation order may be a number of phases that a device transmits using a line code or a subcarrier signal. A symbol duration may comprise one or more data bits or chips. The WTRU may be configured to determine an association between a modulation order and a symbol duration is based on at least one of: a received network configuration, one or more measurements, a previous device transmission, or an indication from a device. The calibration signal may be a signal comprising at least one chip. The broadcast configuration message may include information indicating the determined association between a modulation order and the symbol duration, and at least one symbol duration parameter. The at least one symbol duration parameter may be used to determine the symbol duration. A symbol duration may be determined by multiplying a duration derived from the calibration signal with a value determined from the at least one symbol duration parameter. The modulation order may be determined based on the chip duration. The WTRU may be a reader.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example inventory procedure using RFID;

FIG. 3 shows an example of backscattering modulation;

FIG. 4 shows an example of subcarrier modulation;

FIG. 5 shows an example of a square wave;

FIG. 6 shows an example method of frequency resource allocation;

FIG. 7 shows an example method of frequency resource allocation;

FIG. 8 shows an example of a calibration signal;

FIG. 9 shows an example of chip repetition;

FIG. 10 shows an example method of chip repetition;

FIG. 11a shows an example of a phase-shift keying (PSK) modulation;

FIG. 11b shows an example of frequency-shift keying (FSK) modulation;

FIG. 12 shows an example method of adaptive modulation;

FIG. 13 shows an example method of adaptive modulation; and

FIG. 14 shows an example method of adaptive modulation.

### DETAILED DESCRIPTION

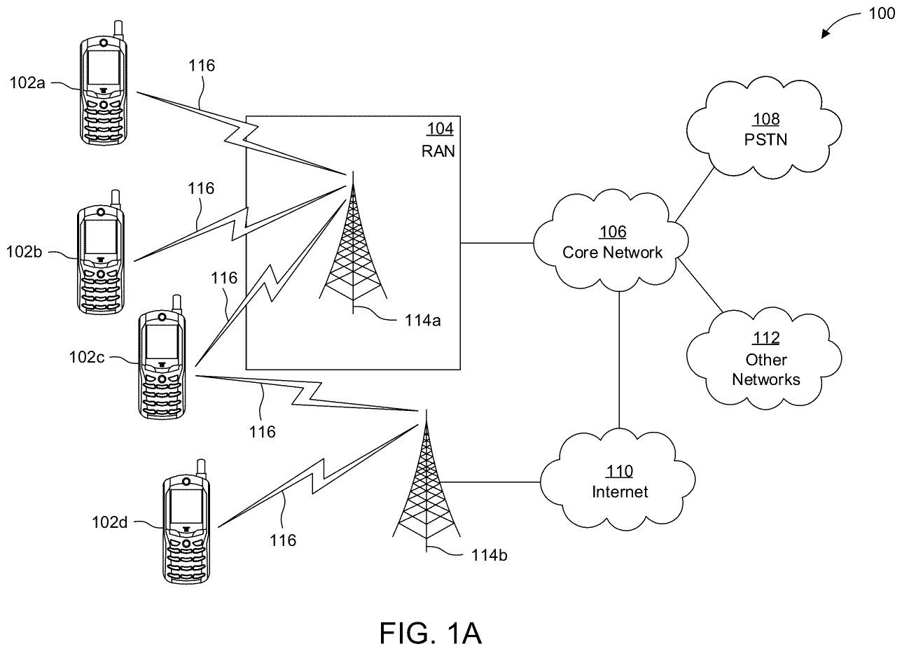

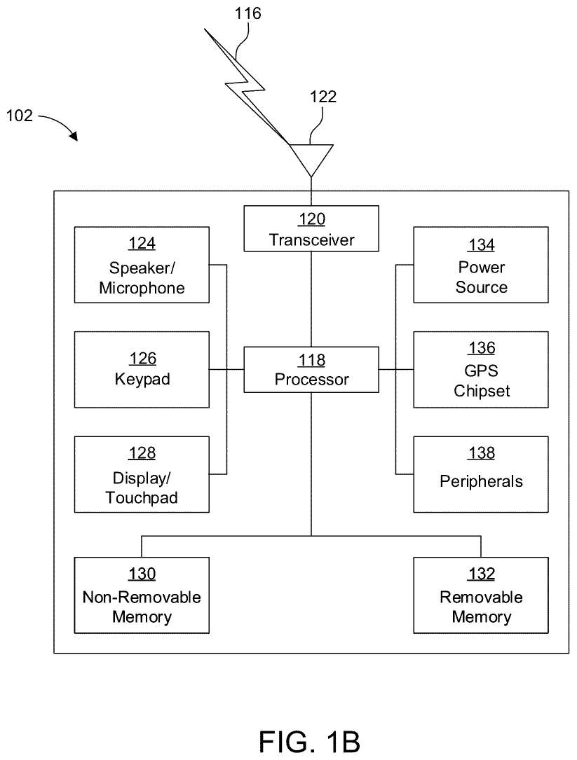

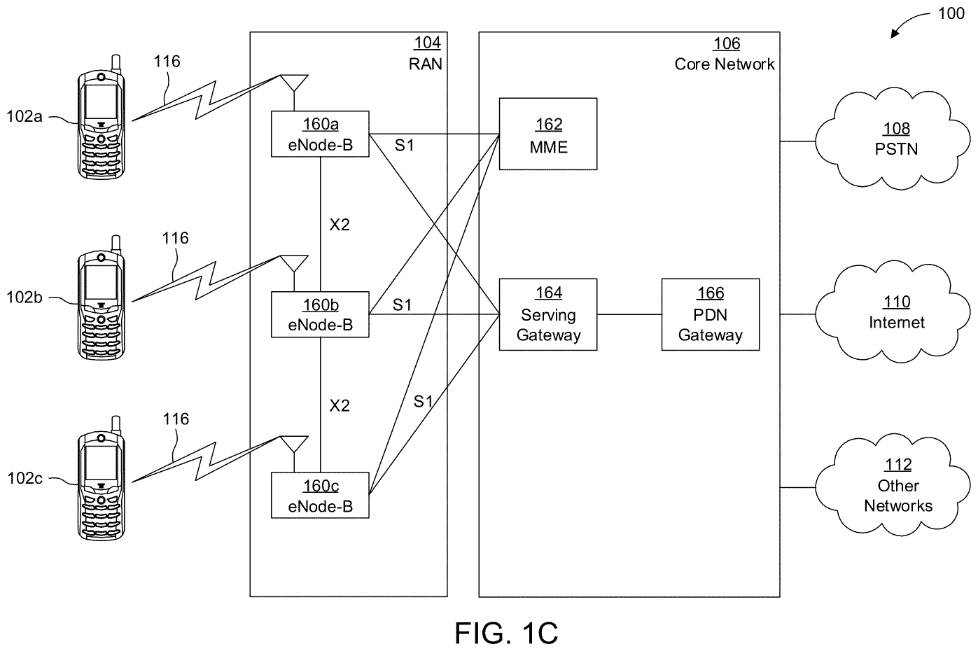

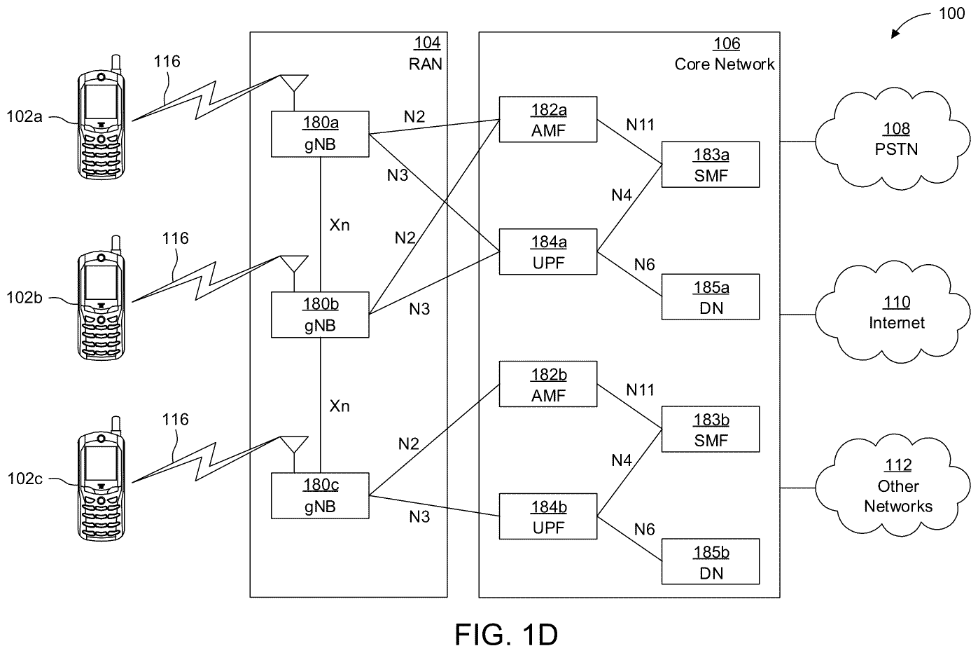

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WT RU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An IoT device may use backscatter modulation to transmit data to a receiver. In backscattering, a device does not generate an RF carrier but receives it from an external source and reflects the received RF signal. The baseband signal may be modulated on the reflected RF carrier. This may be achieved by using an impedance mismatch concept. An antenna impedance may be connected to a load impedance at the device. By changing the reflection coefficient (e.g. by adjusting the load impedance) over time, the amplitude or frequency of the reflected signal may be changed. For example, ON-OFF keying modulation may be achieved by using a non-reflecting state/OFF signal or a reflecting state/ON signal. The radio frequency identification (RFID) specification in is based on backscatter communications wherein RFID tags switch the reflection coefficient between two states based on the data being sent. Amplitude-shift keying (ASK) and phase-shift keying (PSK) are supported by the RFID tags.

In some embodiments, digital bits may be encoded as a sequence of pulses without using a line code. For example, bit 1 may be encoded as a square wave over a finite duration with a first periodicity and bit 0 may be encoded as a square wave over a finite duration with a second periodicity. A baseband processing method that is used in RFID is subcarrier modulation. In this method, a subcarrier signal, that is usually a square wave, is used to multiply the line coded signal. The multiplication may be achieved by a XNOR operation, if voltage levels are unipolar, or scalar multiplication, if voltage levels are polar. The resulting signal may then be transmitted using backscatter modulation. Except for the RF carrier signal, all signals discussed herein may be considered baseband signals.

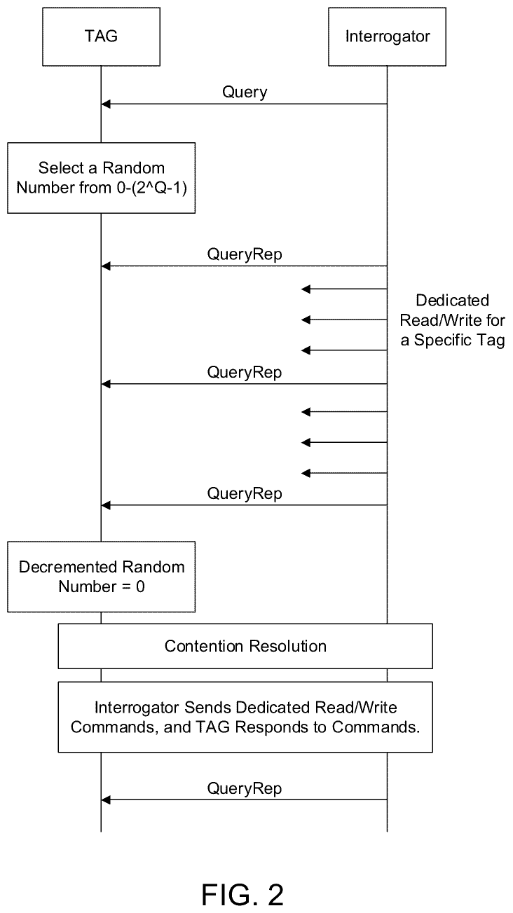

RFID is used for applications of asset identification. FIG. 2 shows a high-level summary of the inventory procedure using RFID. In an RFID inventory procedure, an interrogator sends a Query message to energize all or a subset of TAGs. Following the Query message, a TAG selects a random number from 0-2\hat{ }Q−1 and loads its memory with that number. At each transmission of a QueryRep, the TAG decrements its counter until the counter reaches 0. When the counter reaches 0, the TAG initiates a contention resolution procedure which comprises transmitting its device identification (ID) in the uplink and waiting for confirmation of the device ID in the downlink, to address possible collisions between multiple devices selecting the same random number. For a device that has passed the contention resolution, the interrogator may send multiple read/write commands, to which the TAG may respond.

Modulations that may be used in backscattering IoT include, for example, amplitude-shift keying (ASK) (on-off keying (OOK)), phase-shift keying (PSK), and frequency-shift keying (FSK). In addition, certain modulations may be implemented using line codes, for example the phase of a subcarrier signal multiplying a line coded symbol may carry information. The duration of a chip of a subcarrier signal determines the frequency of the subcarrier modulated signal and the symbol duration determines the data rate. The data rate reduces as the symbol duration increases (e.g., due to poor coverage) and a procedure to improve the spectral efficiency is desirable. In addition, an efficient signaling procedure is needed to indicate to the devices the modulation order and chip rate for example.

The terms device, IOT device, and tag may be used interchangeably herein to mean the IOT device that is being inventoried/queried by a reader. The term reader may refer to an entity which queries the AIOT device. The term reader may refer to a network node or a WTRU, depending on the context and/or the topology. The embodiments described herein as applicable to IOT devices may also be used by other wireless devices such as WTRUs.

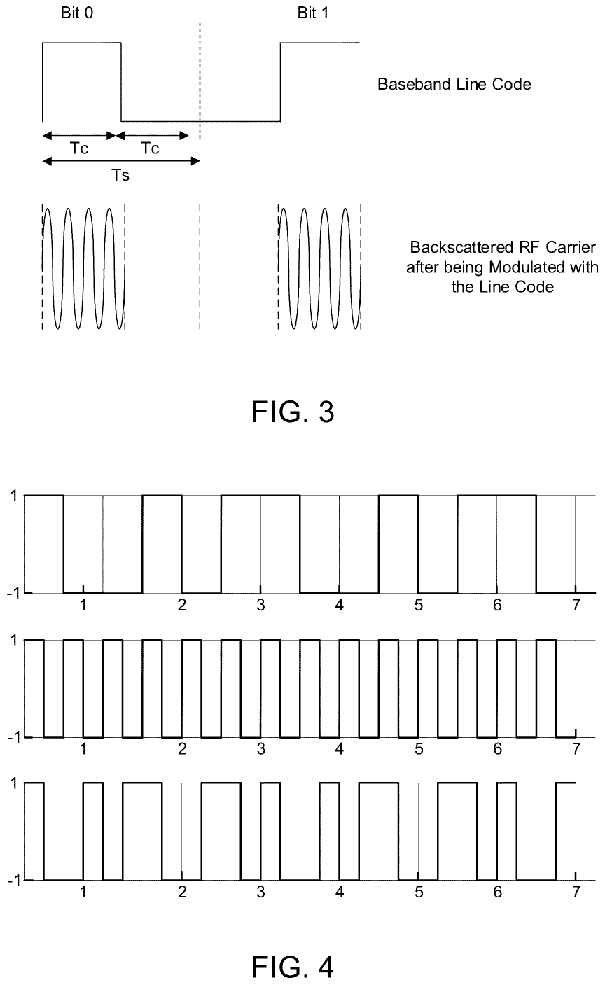

FIG. 3 shows an example of backscattering modulation and some related terminology. Using a line encoding scheme, bit 0 is encoded as a pulse of amplitude 1 followed by a pulse of amplitude 0 and bit 1 is encoded as a pulse of amplitude 0 followed by a pulse of amplitude 1. This is known as Manchester encoding. The bit, or symbol, duration is denoted as Ts. A chip may be defined as the smallest unit of pulse and the amplitude of a chip is assumed to be constant over a chip duration Tc. A symbol may comprise of one or more chips, for example in FIG. 3, each Manchester symbol is comprised of two chips. The baseband line code modulates a received RF sinusoidal carrier. In this example, the amplitude of the backscattered signal is changed depending on the value of the line code chip. For example, when a baseband chip has a value 1, the received RF carrier is reflected as it is during the duration of Tc and when a baseband chip has a value 0, the received RF carrier is absorbed by the device and nothing is backscattered.

Inventory, as discussed herein, may refer to an overall procedure of a reader triggering access by multiple devices using a sequence of messages (e.g., similar to query, followed by query rep in RFID). For example, an inventory procedure may refer to a single round of attempts to have each device respond or attempt to respond with its access ID or perform a random access channel (RACH) procedure. For example, the inventory procedure may refer to a set of access occasions which may have zero or at least one device respond within the access occasion.

Occasion, as discussed herein, may refer to an opportunity for a device transmission that may be delimited by the transmission of a query rep message, or similar. For example, a device may perform a transmission in an occasion by performing an AIOT transmission in a defined time following a query rep associated with that transmission. An occasion may comprise both a time aspect and a frequency aspect. For example, a device may determine an occasion as a transmission following a specific query rep, and by transmitting on one of a number of frequencies (e.g., frequency division multiplexing (FDM)). Wherever embodiments indicate selection of an occasion, they may apply equivalently to a selection of only a time component and/or selection of a frequency component.

A reference to time may be associated with an absolute time measurement (e.g., seconds, slots, or frames). A reference to time may refer to a number of executions of a procedure, which may be triggered by a reader (e.g., number of inventory procedures, or number of accesses or RACH procedures. A reference to time may refer to a number of messages, possibly of a specific type, or comprising specific information, as described herein, received or transmitted.

Configuration or pre-configuration may refer to any configuration received by a message (e.g., a radio resource control (RRC) message, a medium access control (MAC) control element (CE), a physical (PHY) layer signal, a data protocol data unit (PDU), or a control PDU associated with any or a new protocol layer) received from a network node or from another device or WTRU.

A device herein may be configured by a reader. The reader may be a network node or a WTRU. In the case of a WTRU, the WTRU may derive the device configuration itself, or receive the device configuration from the network, in which case, the device configuration may be relayed from the network to the device by the WTRU. A WTRU configuration may be received from a network node (e.g., the gNB).

In some cases, more than one device may transmit to a reader in the same time and/or frequency resources. The time and frequency resources may be fully shared by the transmit devices (e.g. by all transmitting devices) or partially shared by the transmitting devices (e.g. by one or more of the transmitting devices). A device to reader transmission may be referred to as D2R. A reader to device transmission may be referred to as R2D. For example, a first device may transmit in a first subband for a duration of [0:t1] seconds and a second device may transmit in the same subband for a duration of [0:t2] seconds, where t2 is not equal to t1. These devices may be considered to be partially sharing the resources.

In some embodiments, transmissions from devices transmitting simultaneously may be separated in frequency. The bandwidth of a transmission from a device may be determined by the baseband signal used to modulate the carrier wave (e.g., the duration of a chip or the shape of the baseband signal). In an example, a subcarrier modulation scheme may be used and a subcarrier signal (e.g., a square wave with a first chip duration Tc) multiplies line encoded symbols. The resultant signal then may modulate the RF carrier wave using backscatter modulation.

An example of subcarrier modulation is shown in FIG. 4. The top sub-figure shows data bits encoded using Manchester encoding. The middle sub-figure shows the subcarrier modulation signal. The bottom sub-figure shows the signal generated by multiplying the two signals. The impact of this operation is that the spectrum of the Manchester encoded signal is shifted in frequency. The shift may depend on the frequency of the subcarrier modulation signal. The horizontal axis (e.g. 1, 2, . . . 7) in FIG. 4 shows a unit of time (e.g. microseconds). The vertical axis shows amplitude (e.g. amplitude of the signal voltage).

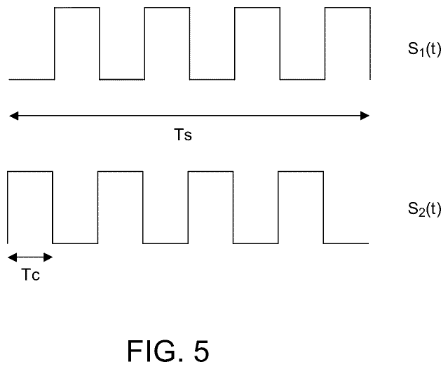

In some embodiments, a device may use a signal (e.g., a square wave signal and/or signals derived from the square wave signal) as the baseband signal to modulate the RF carrier and an aspect/feature/parameter of the square wave may be varied to transmit data. FIG. 5 shows an example of a square wave. Using FIG. 5 as an example, to transmit a 1-bit information, a device may use s1(t) or s2(t) to modulate the RF carrier. As shown in FIG. 5, s1(t) and s2(t) are square waves differentiated with a delay of Tc. In another example, s1(t) and s2(t) may be signals with two different frequencies (e.g., 1/Tc and 1/(2Tc)) and the device may use one or the other to send a 1-bit information. This scheme of using a square wave and its derivatives to modulate a backscatter carrier may be referred to as square wave modulation.

In an embodiment, transmission from a plurality of devices may be multiplexed in frequency. The frequency of a signal may be determined from the line code type and symbol duration, frequency of the subcarrier modulation signal, or the frequency of the square wave in square wave modulation scheme. In an embodiment, the device may need to be indicated (e.g. receive an indication of) the chip duration, or frequency, for the subcarrier modulation scheme or the chip duration, or frequency, for the square wave modulation scheme.

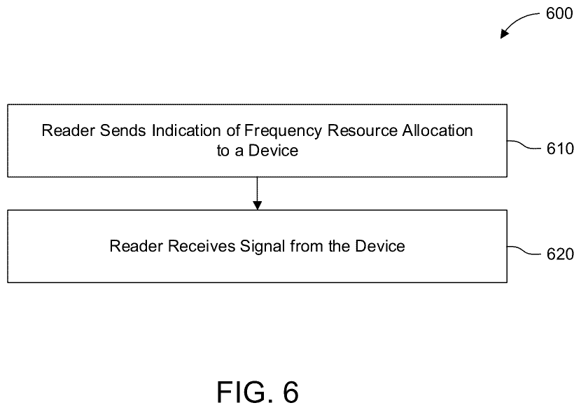

FIG. 6 shows a method 600 of frequency resource allocation. A reader may send a signal or message to a device 610. The signal or message may indicate, directly or indirectly, a frequency resource allocation to use for a D2R transmission, as discussed below. For example, the reader may indicate a chip, bit, or symbol duration with an absolute time, using a signal, or by sending a calibration signal. For example, an aspect or parameter of the signal (e.g. chip duration and/or symbol duration) may indicate which subband to use. The reader may receive, from the device, a signal or message (e.g. D2R transmission) 620 using the indicated frequency resource allocation.

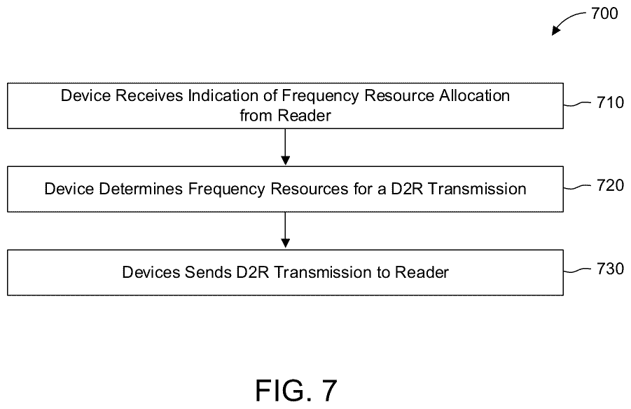

FIG. 7 shows a method 700 of frequency resource allocation. A device may receive a signal or message from a reader 710. The signal or message may indicate, directly or indirectly, a frequency resource allocation to use for a D2R transmission, as discussed below. For example, the reader may indicate a chip, bit, or symbol duration with an absolute time, using a signal, or by sending a calibration signal. For example, an aspect or parameter of the signal (e.g. chip duration and/or symbol duration) may indicate which subband to use. The device may determine frequency resources to use for a D2R transmission 720. The device may determine the frequency resources to use based on the signal or message from the reader. For example, the device may determine a chip duration to use, as described further below. The device may send, to the reader, a signal or message (e.g. D2R transmission) 730 using the determined frequency resources.

In an embodiment, a reader may indicate to a device the frequency allocation of a D2R transmission. The reader may use one or a combination of the following to indicate to a device the frequency allocation of a D2R transmission.

The reader may be configured by the network (e.g. receive a configuration message) with the frequency resources available for a D2R transmission. The configuration information may be received from a gNB. A frequency resource may be divided into smaller resource units, for example, a subband. The frequency of a signal may be determined by an aspect and/or parameter of the signal. For example, a chip duration and/or a symbol duration of a signal may determine which subband the signal is expected to utilize. For example, a square wave baseband signal with chip duration Tc1 may utilize a first subband and a square wave baseband signal with chip duration Tc2 may utilize a second subband. The reader may indicate to a device a frequency resource, for example, by an index associated with the resource (e.g., subband index). From the frequency resource, the device may determine the associated aspect and/or parameter of the baseband signal (e.g., the chip duration of a subcarrier modulation signal).

In an embodiment, a reader may use one or a combination of the following to indicate to a device a chip duration. The same method may apply to indicate bit/symbol durations. Note that since a frequency resource may be associated with a chip/bit/symbol duration, indicating a chip duration would imply indicating a frequency resource.

A reader may indicate a chip (and/or a bit/symbol) duration to a device using absolute time (e.g., in μs). The reader may indicate to a device a chip duration indirectly. For example, a device may determine the chip duration from a data rate, a frequency resource allocation, or a symbol duration. The set of possible chip durations, or the set of parameters(s) from which the duration may be derived, may be in a list or table and the reader may indicate to the device an index from the list.

A reader may indicate a chip (and/or a bit/symbol) duration to a device using a signal. A device may measure the duration of the received signal and determine the chip duration from the measured quantity. The chip duration may be the same duration as the measured quantity, or it may be derived from the measured quantity.

In an embodiment, the reader may send or transmit a calibration signal. The calibration signal may be part of a preamble. The calibration signal may comprise at least one chip duration referred to as base chip duration. The reader may also send, for example in a message, a list of scaling coefficients or pointers to a preconfigured list of coefficients.

A device may determine the chip duration to use for transmission by measuring the base chip duration and then scaling the measured duration with one of the coefficients indicated. The specific coefficient from the list of coefficients may be determined using an index which is preconfigured (e.g., by the reader) and/or determined from a device ID. In an embodiment, a device may determine a symbol duration from the measurement and the chip duration may be derived from the symbol duration. A device may directly measure a chip duration or derive a chip duration from a measurement of the calibration signal. For example, the reader may send a square wave with chip duration Tc, and periodicity 2Tc, as a calibration signal. Further, the reader may indicate and/or configure a set of coefficients as {c1, c2, c3}. A first device, using index 1 to determine coefficient c1, may determine a chip duration as c1Tc, a second device, using index 2 to determine coefficient c2, may determine a chip duration c2Tc, an so on.

In an embodiment, a device may select one of the coefficients randomly (e.g., during a contention random access procedure).

The reader may send or transmit a calibration signal. The calibration signal may be part of a preamble. The calibration signal may comprise one or more chip durations. For example, the calibration signal may comprise a first square wave of periodicity P1 and duration T1 (chip duration is P1/2), and a second square wave of periodicity P2 and duration T2 (chip duration is P2/2), and so on.

A device may measure the chip durations from the calibration signal. The device may determine to use one of the measured chip durations. The index of the chip to use may be preconfigured and/or determined from a device ID. A device may derive the chip durations from measurements of the calibration signal (e.g., measure a symbol duration wherein a symbol may comprise more than one chip, and derive the chip duration from the symbol duration).

In an embodiment, a device may select one of the measured and/or derived chip durations randomly (e.g., during a contention random access procedure).

The reader may send or transmit a calibration signal. The calibration signal may be a part of a preamble. The calibration signal may comprise at least one chip duration. The reader may also send, for example in a message, a list of coefficients or a list of groups of coefficients.

A device may determine the chip duration to use for transmission by measuring the chip durations and then computing or determining a chip duration as a function of the measured durations. The function to apply may have coefficients. The specific coefficient(s) to use may be determined by the device using an index which may be preconfigured and/or determined from a device ID. The index may be used to select one or a group of coefficients from a list.

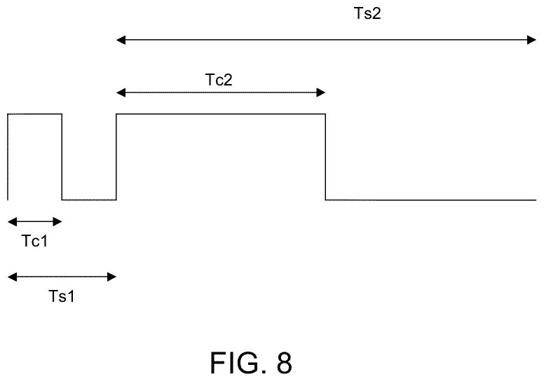

For example, assuming the signal shown in FIG. 8 is a calibration signal, a device may determine a chip duration Tcⁱ as Tcⁱ=αⁱTc1+βⁱTc2 (i=0 . . . , number of devices) where the coefficients αⁱ and βⁱ may be preconfigured and/or determined by the device, for example, based on an assigned index or an index derived from a device ID. Note that a same method may be applied using the symbol durations Ts1 and Ts2 instead of the chip durations. The derived quantity in this case may determine a symbol or a chip duration.

The same methods may be applied for determination of a bit/symbol duration and/or using by the device measurements of bits/symbols. For example, a device may measure two symbol durations from a calibration signal and derive a third duration as a function of the measured durations.

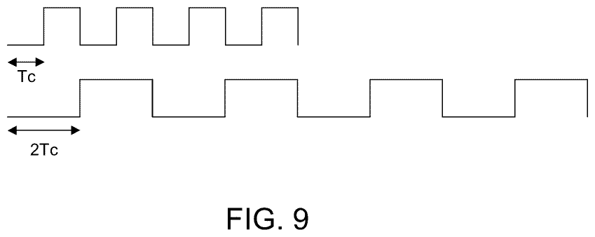

A device may be indicated (e.g. receive an indication) to and/or determine to perform chip repetition during a transmission. FIG. 9 shows an example of chip repetition. Chip repetition may be understood as that a chip is repeatedly transmitted for a specific number of times, referred to as a repetition factor. For example, assume a device applies chip repetition to a signal comprising a square wave with chip duration Tc wherein the repetition factor is denoted as k (e.g., k=2). The chip duration after repetition would be kTc (i.e. 2Tc), as shown in FIG. 9.

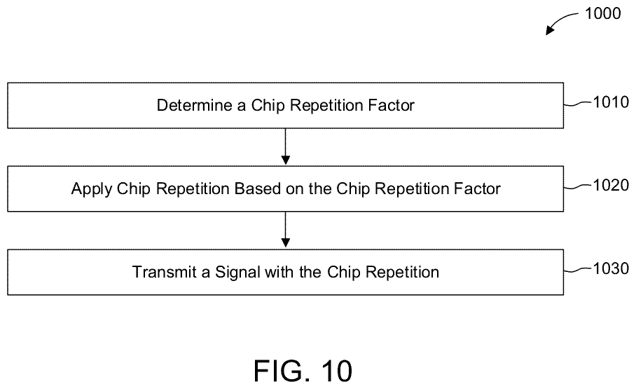

FIG. 10 shows an example method of chip repetition. A node may determine a repetition factor for chip repetition 1010. A node may be a device, reader, WTRU, or network node (e.g. gNB, base station). The node may apply chip repetition based on the determined chip repetition factor 1020. The node may transmit a signal or message with the chip repetition 1030.

A device may apply the repetition to a group of chips. A group of chips may be consecutive in time and the number of chips in the group may be more than one. The device may apply the repetition to a group of chips such that the whole group of chips may be repeated instead of repeating individual chips. For example, if a symbol includes two chips and a chip repetition is applied to a group of two chips, then this repetition is equivalent to symbol repetition. Note that chip repetition may be performed by any of the nodes such as a reader (e.g., a WTRU), a gNB, or a device, and embodiments may be applicable to all nodes.

In an embodiment, a device may be indicated (e.g. receive a message) to and/or determine to apply a first repetition factor to a first type of chip and a second repetition factor to a second type of chip. The type of a chip may be determined from or may be based on the value of the chip. For example, the signal to transmit may comprise chips of duration Tc and values 1 and 0 and a device may apply a repetition factor k1 to a “1” chip and may apply repetition factor k2 to a “0” chip.

In an embodiment, the type of the chip may be determined from the type of signal the chip belongs to. For example, the chip may be part of a line encoded signal, or a subcarrier modulation signal, or the baseband signal to modulate the RF carrier. These signals may be assumed to be of different types.

In an embodiment, the reader may indicate a separate repetition factor for each type of chip. In an embodiment, the reader may indicate a group of repetition factors (e.g., a pair of repetition factors) and a device may apply or determine to apply a first repetition factor from the group to a first type of chip, a second repetition factor from the group to a second type chip, and so no. The repetition factors may be configured by the reader (e.g., sent in a control message) and the indication may comprise an index to one or a group of configured repetition factors.

In an embodiment, a reader and/or a device may determine to apply chip repetition wherein the chip repetition factors may be different for different types of chips. A device may determine the chip repetition factor based on one or more (e.g., a combination) of the following.

A device may determine the chip repetition factor based on a coverage level. A coverage level may be defined as an attribute characterizing the coverage of a device. For example, a reader and/or a device may determine to apply a first repetition factor to chip “1” and a second repetition factor to chip “0” in a first coverage level. For example, as the coverage level reduces, a device may apply a larger repetition level to chip “1” than to chip “0” so that the D2R transmission power increases. In an example, a reader may indicate (e.g., configure/provide in a control message) repetition factor(s) per coverage level and a device in a specific coverage level may apply the associated repetition factors. In an example, a device may select the repetition factors (e.g., from a list or table of configured factors). The device may indicate to a reader the repetition factors by applying the same repetition factors to a known/predefined signal such as a preamble.

A device may determine the repetition factors based on its energy level (e.g., energy stored in a battery or capacitor). For example, a device with a lower energy level may determine to apply a larger repetition factor to chip “0” to be able to harvest more energy during chip “0” since the received carrier may be absorbed and not backscattered.

The repetition factors to apply by a first node may be determined by a second node and indicated to the first node. For example, a reader may determine the repetition factors to apply by a device and indicate it to the device. The repetition factor may be selected from a list of repetition factors (e.g., configured by the gNB, network). The reader may indicate to a device a repetition factor common for all chip types. The reader may indicate to a device a repetition factor for each chip type, for example, using an index wherein the index may point to a specific value in a table or list. An index may determine jointly the repetition factors. For example, for two chip types, a table may include repetition factor pairs {2,1}, {2,2}, {4,2}, {4,4} and the reader may indicate a first and second repetition factor for a first and second chip type by indicating one of these four pairs.

A device may determine the repetition factors autonomously. The device may determine the repetition factors autonomously from a list of allowed repetition factors. The allowed repetition factors may be predefined and/or preconfigured.

A device may apply repetition according to one or a combination of the following.

The device may encode bits (e.g., information bits) using a line code. The output of the line code may be multiplied with a subcarrier signal to generate a baseband signal that may modulate a carrier wave. The reader may indicate to the device a first repetition factor and a second repetition factor. The device may determine a first repetition factor and a second repetition factor. The device may apply the first repetition factor to the chips of the line code output and the second repetition factor to the chips of the subcarrier signal. The first repetition factor may be used to adjust the bit/symbol duration, for example to control coverage. The second repetition factor may be used to adjust the frequency allocation of the D2R transmission. It may also be possible to apply repetition to one signal only. The device may apply a repetition factor to the chips of the signal to modulate the carrier wave. This signal for example may be a line code output modulated with a subcarrier signal.

A device may determine the repetition factor and/or the chip type to which to apply the repetition based on one or more of the following.

The device may determine the repetition factor and/or the chip type to which to apply the repetition based on a coverage level. For example, to increase coverage, a device may apply chip repetition to the chips of a bit/symbol, for example to the chips of a line code only, and not to the chips of the subcarrier modulation signal, and/or to the baseband signal to modulate the RF carrier.

The device may determine the repetition factor and/or the chip type to which to apply the repetition based on a frequency resource. For example, a device may determine to increase a chip repetition factor if a resource with a smaller frequency is allocated. For example, if the center frequency of a resource is reduced from F to F/2, then the device may determine to increase the chip duration by using a repetition factor of two. Note that there may be an inverse relationship between the center frequency and chip duration.

Repeating symbols (e.g., Manchester encoding symbols) may be equivalent to repeating symbols/bits that are an input to the symbol generation unit (e.g., the line encoder).

A device may apply chip repetition (and/or bit repetition) based on an outcome of a previous transmission. For example, during random access, the device may send a random ID to the reader and may monitor for an acknowledgement from the reader. When the device does not receive an acknowledgement during a monitoring window, (e.g., due to the failure of the D2R transmission), the device may perform a retransmission. The device may apply chip repetition and/or bit repetition to the to the D2R transmission corresponding to the retransmission.

The device may apply a repetition factor of k, over the previous repetition, to each retransmission. For example, the device may perform a first D2R transmission. If the transmission is not acknowledged (e.g. the device does not receive an acknowledgement), the device may perform a retransmission while repeating each chip by two times. If another retransmission is needed, the device may perform another retransmission while repeating each chip by four times, and so on. The chip repetition factor in each associated transmission (i.e. initial transmission and retransmissions) may be computed or determined as kᵢ=nkᵢ₋₁ (n may be a predefined/preconfigured integer, i is the transmission index and i=0 is the initial transmission, k₀=1, i=1, 2, . . . ) or kᵢ=kᵢ₋₁+m (m may be predefined/preconfigured integer).

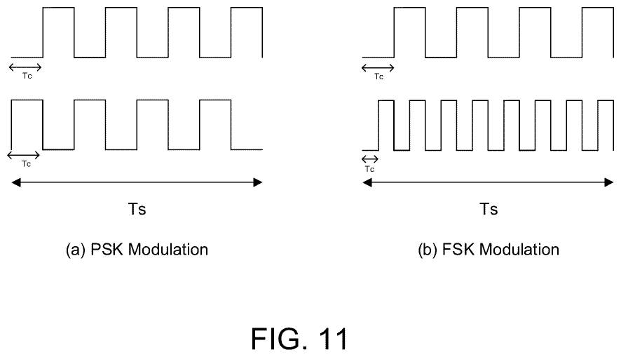

An aspect and/or parameter such as the phase or frequency of a baseband signal may be used to transmit data. For example, FIG. 11a shows two baseband signals of symbol duration Ts that are differentiated by a delay, which may be referred to as a phase (e.g. phase-shift keying (PSK)), that is half the square wave periodicity. A device may select to use one or the other (i.e. the top or bottom signal of FIG. 11a) signal to modulate an RF carrier. The selection may depend on the value of a bit (referred to as BPSK). Similarly, the two signals in FIG. 11b are differentiated by two different frequencies for the square wave (e.g. frequency-shift keying (FSK)) and a device may select the signal with the higher or lower frequency to send a 1-bit information. In general, a device may make use of more than two variations of a signal. For example, a device may transmit a two-bit information (referred to as QPSK) by selecting one out of four signals wherein the four signals may be differentiated from each other by four different delay values (e.g., 0, T/4, T/2, and 3T/4), where T may be the periodicity of the square wave. The following embodiments may use delay/phase modulation as an example, but they may be applicable to other modulation schemes. As shown in FIG. 11a, PSK modulation, the chip duration is Tc=T/2 and as the modulation order increases, the chip duration may reduce. For example, to perform QPSK modulation with four different delay values, chip duration may become T/4.

A device may not be able to receive and/or transmit with sufficient reliability beyond a specific chip duration. For example, a device with a poor clock may not be able transmit a signal with chip duration T/4 but it may be able to transmit with a chip duration T/2. Similarly, a device in a poor coverage area may not be able to receive a signal with a chip duration below a certain duration.

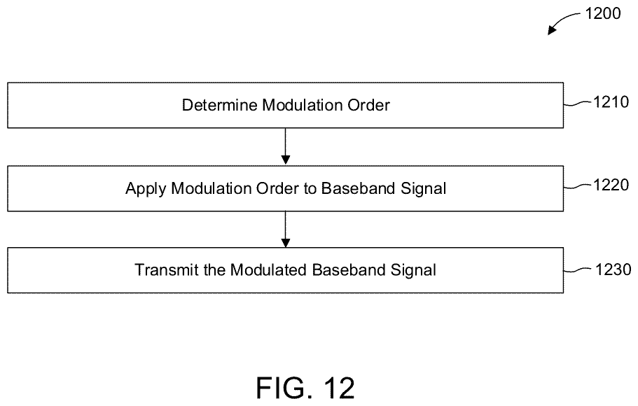

FIG. 12 shows an example method for adaptive modulation. A device may determine a modulation order 1210. The device may determine a modulation order based on for example, a symbol duration, a change in symbol duration, an energy level, a coverage level, and/or a frequency/subband index. The device may apply the modulation order to a baseband signal 1220. The device may transmit the modulated baseband signal 1230.

A device may determine to apply a modulation order in a baseband signal (e.g., BPSK or QPSK by varying the delay parameter as described above) based on one or more of the following.

The device may determine to apply a modulation order in a baseband signal based on a symbol duration. A modulation order may be associated with or determined from a bit/symbol duration. In an example, a list of possible modulation orders may be defined (e.g. by the reader sending in a configuration information in a control message) for a given symbol duration. For example, for a first symbol duration BPSK and QPSK may be defined and for a second symbol duration BPSK, QPSK, and 8-PSK may be defined. In an example, the reader may indicate and/or configure modulation schemes associated with bit/symbol durations wherein a duration may be an interval. For example, a duration may be between t1 μs and t2 μs.

The device may determine to apply a modulation order in a baseband signal based on a change in a symbol duration. For example, a device may be indicated to use BPSK with a first symbol duration. When the symbol duration is increased (e.g., the symbol duration may be increased for better coverage), the device may determine to start using QPSK. The device may start using a higher order modulation only if the new modulation order is allowable for the new symbol duration (e.g., by configuration and/or predefinition).

The device may determine to apply a modulation order in a baseband signal based on an energy level. For example, the device may determine to use a higher order modulation (e.g., if allowed with the symbol duration) if the energy level at the device falls below a threshold value. In another example, the device may determine to use a lower order modulation if the energy level is above a threshold value. In general, the device may determine the modulation order based on at least the energy level of the energy storage at the device. In an example, a device may dynamically adjust and/or change the modulation order during a transmission. For example, a device may be transmitting a transport block and during the transmission the device may determine the energy level to fall, (e.g., below a threshold value). The device may determine to increase the modulation order so as to finish the transmission, for example before the energy is depleted. In another example, a device may reduce the modulation order during a transmission if the energy level rises above a threshold value, for example to improve reliability. The new modulation order may be indicated to the reader with a sequence (e.g., a midamble), in a control message and/or the reader may determine it blindly.

The device may determine to apply a modulation order in a baseband signal based on a coverage level. For example, the device may determine to use a higher order modulation (e.g., if allowed by the symbol duration) at a larger coverage level.

The device may determine to apply a modulation order in a baseband signal based on a frequency/subband index. The device may determine a modulation order from a frequency resource assignment. For example, the device may use BPSK for a first frequency resource assignment, the device may determine to use QPSK for a second frequency assignment (e.g., the center frequency Fc of the second frequency assignment is larger than the center frequency of the first frequency assignment). In an example, the device may determine the chip duration as 1/2Fc (or 1/Fc or a similar formula depending on the exact definition of Fc) and then apply the modulation order associated with the chip duration. For example, if the chip duration is halved at the new Fc, the modulation order M (as in M-PSK) may be doubled

A reader may determine the chip durations that a device may support (i.e., the chip durations that a device may transmit with or detect with sufficient reliability). A reader may transmit a training signal. The training signal may be referred to as a reference signal, a pilot signal, or a preamble. The training signal may comprise one or more chips of at least one duration. The number of chips and/or the length of the training signal may be predefined and/or configured, (e.g., in a control message).

A device may perform measurements on the received training signal and may report one or more of the following (e.g. to a reader): detected chip duration(s) in terms of absolute time, number of clock cycles, in terms of a predefined unit (e.g., multiples of that unit); an interval to which the chip duration may fall into (e.g., report may indicate that the chip duration is between 1 and 1.5 microseconds); a time between rising and falling edges (and/or vice versa) of chip(s) wherein there may be one time value for the chip(s) of one duration; the smallest time between rising and falling edges of chips; a parameter to quantify the number of rising/falling edges (e.g., absolute number of only rising edges or only falling edges); the number of chips detected; the number of chips with different durations detected; the number of different durations associated with at least one chip (e.g. the device may report 3 durations if the device detects chips with durations 1 μs, 2 μs and 4 μs); a preferred chip duration (e.g., the smallest chip duration the device may have detected and/or the smallest chip duration the device may support (may be different for D2R and R2D)).

The device may send to the reader a signal. The signal may comprise at least one chip and the chip may be of a first duration. The chip duration may be a duration preferred by the device for transmission by the reader and/or the device. Note that the same methods and procedures may similarly apply if another duration instead of chip duration is used (e.g., periodicity).

Upon receiving the report, a reader may determine the chip duration to use (e.g., when transmitting to the device and/or by the device). A device may transmit a training signal comprising one or more chips of at least one duration. The reader may determine, from the training signal, one or more chip/symbol durations the device may use for transmission to the reader.

In an embodiment, a reader may indicate to a device the modulation order (e.g., to be used in a D2R transmission) by transmitting one or more calibration signals. In an example, the number of different durations associated with chips in one or more of the calibration signals may indicate the modulation order for M-PSK. For example, if the calibration signals comprise chips of one single duration, then the device may determine the modulation as BPSK. If the calibration signals comprise chips of two different durations, then the device may determine the modulation as QPSK, and so on. Similarly, the number of different frequencies associated with chips in one or more of the calibration signals may indicate the modulation order for M-FSK. For example, if the calibration signals comprise chips of one single frequency, then the device may determine the modulation as 2-FSK. If the calibration signals comprise chips of four different frequencies, then the device may determine the modulation as 4-FSK, and so on.

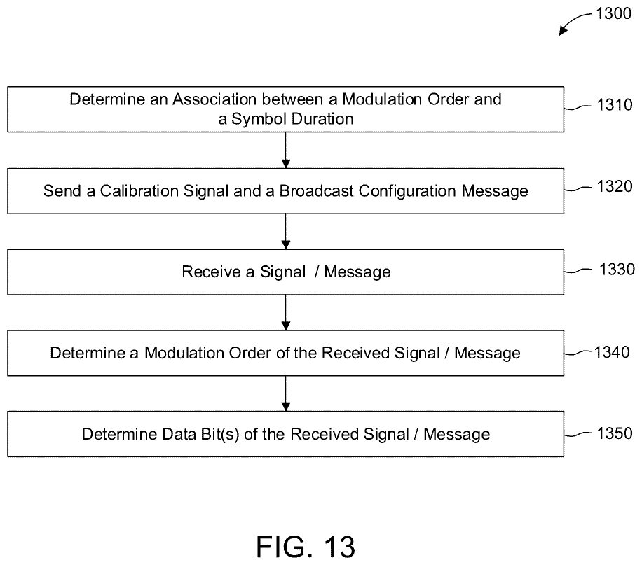

FIG. 13 show an example method of adaptive modulation.

A reader (e.g., a WTRU) may determine a mapping or association between a modulation order and a symbol duration 1310. The modulation order and/or symbol duration may be configured by the network. For example, the WTRU may receive a message from the network that includes an indication of a modulation order and/or symbol duration. A modulation order may be, for example, the number of phases a device can transmit using a line code and/or subcarrier signal. A symbol may be a data bit or a chip. The WTRU may determine a mapping between a modulation order and a symbol duration based on at least one of: a network configuration, one or more measurements, a previous device transmission, or an indication from a device. In an example, the network may indicate and/or configure certain transmission parameters (e.g., using one or a combination of RRC message, MAC control element, or control signaling). For example, the network may configure a range of symbol durations and the modulation orders that may be used for that range of symbol durations. The reader may configure a device with a modulation order (for a given symbol duration) with one of the modulation orders configured in the RRC message. In an example, the reader may perform measurements on certain signals transmitted by the device, for example the reader may measure a RSRP or SINR from a preamble transmitted by the device. Based on these measurements, the reader may adapt the data rate of the device (e.g., by adapting the durations of the symbol(s)/bit(s) transmitted by the device and/or the modulation order). In an example, if the signal power from the device is above a threshold value, the reader may indicate to the device to increase the modulation order or the device may determine to increase the modulation order if the symbol/bit duration is increased beyond a threshold value by the reader.

The reader may transmit, to one or more devices, a calibration signal and a broadcast configuration message 1320. The calibration signal may be, for example a signal comprising at least one chip. The broadcast configuration message may include the determined mapping (i.e. mapping between a modulation order and a symbol duration), and at least one symbol duration parameter. A symbol duration parameter may be for example scaling coefficients. The device may scale the measurement(s) with the signaled coefficient(s). For example alpha and beta coefficients as discussed above. The at least one symbol duration parameter may be used by a device to determine at least one symbol duration. For example, a symbol duration may be determined by the device by multiplying a duration derived from the calibration signal with a value determined from the parameter. The calibration signal and the broadcast configuration message may be transmitted at a same time or a different time. The calibration signal and the broadcast configuration message may be transmitted in a same message or a different message.

The reader may receive a signal or message 1330 with a frequency corresponding to a chip duration. The chip duration may be determined by a device. The chip duration may be determined by the reader based on the received signal (e.g. a preamble and/or data signal).

The reader may determine a modulation order of the received signal 1340 based on the determined chip duration.

The reader may determine the data bit(s) of the received signal 1350 based on a phase of the received signal over a duration of a symbol duration and the determined modulation order.

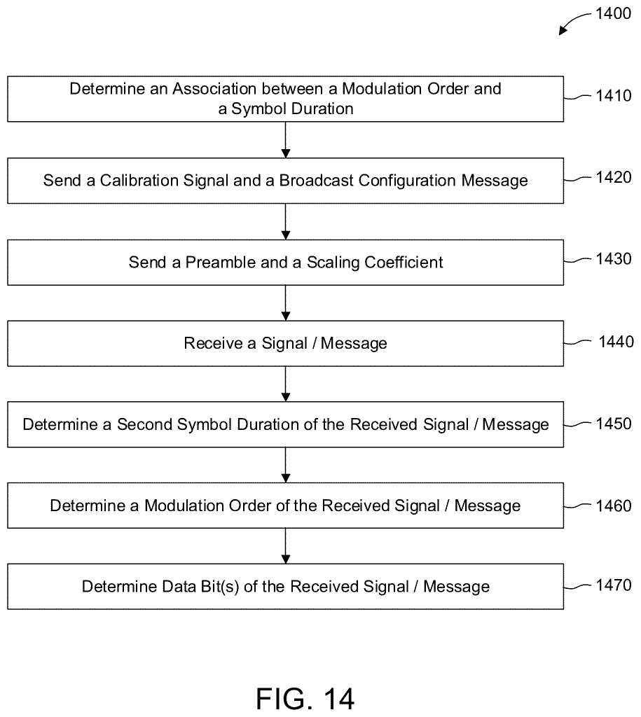

FIG. 14 shows an example method of adaptive modulation.

A reader (e.g., a WTRU) may determine a mapping or association between a modulation order and a symbol duration 1410. A modulation order may be, for example, the number of phases a device can transmit using a line code and/or subcarrier signal. A symbol may be a data bit or a chip. The WTRU may determine a mapping between a modulation order and a symbol duration based on at least one of: a network configuration, one or more measurements, a previous device transmission, or an indication from a device.

The reader may transmit, to one or more devices, a calibration signal and a broadcast configuration message 1420. The calibration signal may be, for example a signal comprising at least one chip. The broadcast configuration message may include the determined mapping (i.e. mapping between a modulation order and a symbol duration), and at least one symbol duration parameter. The at least one symbol duration parameter may be used by a device to determine at least one symbol duration. For example, a symbol duration may be determined by the device by multiplying a duration derived from the calibration signal with a value determined from the parameter. The calibration signal and the broadcast configuration message may be transmitted at a same time or a different time. The calibration signal and the broadcast configuration message may be transmitted in a same message or a different message.

The reader may transmit, to one or more devices, a preamble and one or more scaling coefficients 1430. The preamble may comprise one or a plurality of chips. The one or more scaling coefficients may be sent in a control message using a first symbol duration. A device may determine a chip duration as a function of one or more of: the indicated chip duration(s) and one or more scaling coefficients. The one or more scaling coefficients may be device-specific. A device may determine the scaling coefficient(s) to use from the list of coefficients(s) based on at least its device ID.

The reader may receive a signal or message 1440 (e.g., from one or a plurality of devices) comprising line encoded bits modulated with a subcarrier signal (e.g., square wave subcarrier signal) with a frequency corresponding to the chip duration determined by a device and a modulation order associated with the first symbol duration. The reader may first monitor to receive the signal or message and then receive the signal or message.

The reader may determine a second symbol duration of the received signal 1450. The received signal may be, for example, a preamble. The device may determine and use a second symbol duration as a function of the control message first symbol duration.

The reader may determine a modulation order of the received signal 1460 based on the determined second symbol duration and the determined mapping.

The reader may determine the data bit(s) of the received signal 1470 based on the phase of the received signal over a duration of the second symbol duration and the determined modulation order.

A carrier wave may be generated internally at a device and methods, embodiment, and examples disclosed/described herein apply similarly.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a wireless transmit/receive unit (WTRU), the method comprising:
determining an association between a modulation order and a symbol duration;
transmitting a calibration signal;
transmitting a broadcast configuration message;
receiving a signal with a frequency corresponding to a chip duration;
determining a modulation order of the received signal; and
determining data bits of the received signal based on a phase of the received signal over a duration of the symbol duration and the determined modulation order.

2. The method of claim 1, wherein the modulation order is a number of phases that a device transmits using a line code or a subcarrier signal.

3. The method of claim 1, wherein a symbol duration comprises one or more data bits or chips.

4. The method of claim 1, wherein the determining an association between a modulation order and a symbol duration is based on at least one of: a received network configuration, one or more measurements, a previous device transmission, or an indication from a device.

5. The method of claim 1, wherein the calibration signal is a signal comprising at least one chip.

6. The method of claim 1, wherein the broadcast configuration message includes information indicating the determined association between a modulation order and the symbol duration, and at least one symbol duration parameter.

7. The method of claim 6, wherein the at least one symbol duration parameter is used to determine the symbol duration.

8. The method of claim 6, wherein a symbol duration is determined by multiplying a duration derived from the calibration signal with a value determined from the at least one symbol duration parameter.

9. The method of claim 1, wherein the modulation order is determined based on the chip duration.

10. The method of claim 1, wherein the WTRU is a reader.

11. A wireless transmit/receive unit (WTRU) comprising:
a receiver;
a transmitter; and
a processor, wherein:
the processor is configured to determine an association between a modulation order and a symbol duration;
the transmitter is configured to transmit a calibration signal;
the transmitter is further configured to transmit a broadcast configuration message;
the receiver is configure to receive a signal with a frequency corresponding to a chip duration;
the processor is further configured to determine a modulation order of the received signal; and
the processor is further configured to determine data bits of the received signal based on a phase of the received signal over a duration of the symbol duration and the determined modulation order.

12. The WTRU of claim 11, wherein the modulation order is a number of phases that a device transmits using a line code or a subcarrier signal.

13. The WTRU of claim 11, wherein a symbol duration comprises one or more data bits or chips.

14. The WTRU of claim 11, wherein the processor is configured to determine an association between a modulation order and a symbol duration is based on at least one of: a received network configuration, one or more measurements, a previous device transmission, or an indication from a device.

15. The WTRU of claim 11, wherein the calibration signal is a signal comprising at least one chip.

16. The WTRU of claim 11, wherein the broadcast configuration message includes information indicating the determined association between a modulation order and the symbol duration, and at least one symbol duration parameter.

17. The WTRU of claim 16, wherein the at least one symbol duration parameter is used to determine the symbol duration.

18. The WTRU of claim 16, wherein a symbol duration is determined by multiplying a duration derived from the calibration signal with a value determined from the at least one symbol duration parameter.

19. The WTRU of claim 11, wherein the modulation order is determined based on the chip duration.

20. The WTRU of claim 11, wherein the WTRU is a reader.
